(19) United States
(12) Patent Application Publication
(10) Pub. No.: US 2013/0016890 A1
(43) Pub. Date: Jan. 17, 2013

(54) METHOD AND APPARATUS FOR PROCESSING AN IMAGE USING MULTI RESOLUTION TRANSFORMATION

(71) Applicants: Hyun-taek LEE, Seoul (KR); Jae-chool LEE, Suwon-si (KR); Hyun-seung LEE, Yongin-si (KR); Hae-kyung JUNG, Seoul (KR); Jong-geun PARK, Seoul (KR); Hee-chul YOON, Seoul (KR)

(72) Inventors: Hyun-taek LEE, Seoul (KR); Jae-chool LEE, Suwon-si (KR); Hyun-seung LEE, Yongin-si (KR); Hae-kyung JUNG, Seoul (KR); Jong-geun PARK, Seoul (KR); Hee-chul YOON, Seoul (KR)

(73) Assignee: SAMSUNG ELECTRONICS CO., LTD., Gyeonggi-do (KR)

(21) Appl. No.: 13/549,276

(22) Filed: Jul. 13, 2012

(30) Foreign Application Priority Data
Jul. 13, 2011 (KR) 10-2011-0069494

(51) Int. Cl. G06K 9/00

(52) U.S. Cl. 382/131; 382/128; 382/132

(57) ABSTRACT

A method of processing an image is disclosed. The method includes transforming an original image to generate an edge image by using multi-resolution transformation; performing a first image enhancement process on the edge image according to a type of original image; generating an inverse transform image by performing inverse multi-resolution transformation on the edge image; and performing a second image enhancement process on the inverse transform image according to a type of original image, thereby enhancing image quality.

### CROSS-REFERENCE TO RELATED PATENT APPLICATION

This application claims the benefit of Korean Patent Application No. 10-2011-0069494, filed on Jul. 13, 2011, in the Korean Intellectual Property Office, the disclosure of which is incorporated herein in its entirety by reference.

### BACKGROUND

1. Field of the Invention

The present inventive concept relates to a method and apparatus for processing an image more particularly, the method and apparatus relate to processing an image using multi-resolution transformation.

2. Description of the Related Art

There are several methods of capturing an image, such as general photographing for capturing an image without irradiation using a light of a predetermined wavelength, x-ray photography for capturing an image by irradiating radioactive rays on an object to be x-rayed and magnetic resonance imaging (MRI) photography for capturing an image by using a magnetic field. The method may differ based on the purpose of the photography. Characteristics of an image may differ based on the type of image. Thus, methods of image processing may differ.

For example, an image may be processed by performing noise reduction, edge enhancement, or by color compensation process for increasing or decreasing brightness or contrast. Accordingly, image quality may be enhanced.

In order to increase the satisfaction of a user, the image may be processed to enhance image quality. Accordingly, a method and apparatus for improving image quality may be provided.

### SUMMARY

The present inventive concept provides a method and apparatus for processing an image, which output an enhanced image by using multi-resolution transformation.

The present inventive concept also provides a method and apparatus for processing an image, which enhance image quality by changing the method depending on the type of image.

According to an aspect of the present inventive concept, there is provided a method of processing an image, the method including: generating an edge image by transforming an original image by using multi-resolution transformation; performing a first image enhancement process on the edge of the image according to the type of original image; generating an inverse transform image by performing inverse multi-resolution transformation on the edge image; and performing a second image enhancement process on the inverse transform image according to the type of original image.

The method may further include: determining the type of the original image; and determining at least one of the first image enhancement process and the second image enhancement process according to the determined image type.

The performing of the first image enhancement process may include performing at least one of a noise reduction process, an edge enhancement process, and a contrast enhancement process on the edge image, according to the type of the original image, and the performing of the second image enhancement process may include performing at least one of the noise reduction process, the edge enhancement process, and the contrast enhancement process, except for a process that is performed on the edge image, on the inverse transform image, according to the type of original image.

The method may further include determining whether the original image is an x-ray image or an ultrasonic image.

The performing of the first image enhancement process may include performing the noise reduction process on the edge image in response to the original image being determined to be an ultrasonic image.

The performing of the second image enhancement process may include performing at least one of the edge enhancement process and the contrast enhancement process on the inverse transform image in response to the original image being determined to be an ultrasonic image.

The performing of the first image enhancement process may include performing at least one of the edge enhancement process and the contrast enhancement process on the edge image in response to the original image being determined to be the x-ray image.

The performing of the second image enhancement process may include performing the noise reduction process on the inverse transform image in response to the original image being determined to be the x-ray image.

The generating of the edge image may further include repeatedly performing the multi-resolution transformation on the original image a predetermined number of times according to a resolution applied to the original image.

The generating of the inverse transform image may further include repeatedly performing the inverse multi-resolution transformation a predetermined number of times.

The generating of the edge image may further include generating an edge map comprising edge information of at least one object included in the transformed original image.

According to another aspect of the present inventive concept, there is provided an apparatus for processing an image, the apparatus including: an image input block for receiving an original image; and a multi-resolution image processing block comprising a plurality of image processors for analyzing and synthesizing the original image transmitted from the image input block by using multi-resolution transformation, wherein each of the plurality of image processors transforms the original image by using the multi-resolution transformation, generates an edge image corresponding to the transformed original image, performs a first image enhancement process on the edge image according to a type of the original image, generates an inverse transform image by performing inverse multi-resolution transformation on the edge image, and performs a second image enhancement process on the inverse transform image according to a type of an original image.

According to another aspect of the inventive concept, an apparatus is provided for processing an image, the apparatus comprising a multi-resolution image processing block which comprises an analysis unit which transforms an input original image by generating an edge image using multi-resolution image transformation; a processor which performs a first image enhancement process on the edge image; a synthesis unit which generates an inverse transform image by performing inverse multi-resolution transformation on the edge image, and the processor performing a second image enhancement process on the inverse transform image.

According to another aspect of the inventive concept, the apparatus further comprises a control block which determines the type of the original image and determines at least one of the first image enhancement process and the second image enhancement process, based on the determined type of original image.

According to yet another aspect of the inventive concept, the analysis unit is a scale unit and the synthesis unit is a scale synthesis unit which inverse scales the edge image such that the inverse scaled image is the same size as the original image.

According to a further aspect of the exemplary embodiments, the multi-resolution image processing block further comprises a plurality of image processors which are connected in stages.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other features and advantages of the present inventive concept will become more apparent by describing in detail exemplary embodiments thereof with reference to the attached drawings in which:

FIG. 1 is a diagram of an apparatus for processing an image, according to an exemplary embodiment;

FIG. 2 is a flowchart illustrating a method of processing an image, according to an exemplary embodiment;

FIG. 3 is a diagram of an apparatus for processing an image, according to another exemplary embodiment;

FIG. 4 is a flowchart illustrating a method of processing an image, according to another exemplary embodiment;

FIG. 5 is a flowchart illustrating a method of processing an image, according to another exemplary embodiment;

FIG. 6 is a view of an original image transmitted from an image input block of FIG. 3;

FIG. 7 is a view of an image output from a scale unit of FIG. 3;

FIG. 8 is a view of an image output from a first enhancement processor;

FIG. 9 is a view of an image output from a scale synthesis unit of FIG. 3;

FIG. 10 is a view of an image output from a second enhancement processor of FIG. 3;

FIGS. 11A and 11B are views of an input image and an output image according to an exemplary embodiment; and

### DETAILED DESCRIPTION OF THE INVENTION

Various methods and apparatuses for capturing an image for use in determining the existence of a disease in a human body are being developed in medical imaging fields. Since tissue sizes of the human body vary, a multi-resolution transform image processing technology is widely used so as to scale at least one of an image size and a resolution according to the tissue size. Since multi-resolution transform image processing technology is well known to one of ordinary skill in the art, details thereof will be omitted herein.

Hereinafter, a method and apparatus for processing an image according to exemplary embodiments of the present inventive concept, which are used to output an enhanced image by using multi-resolution transformation, will be described in detail.

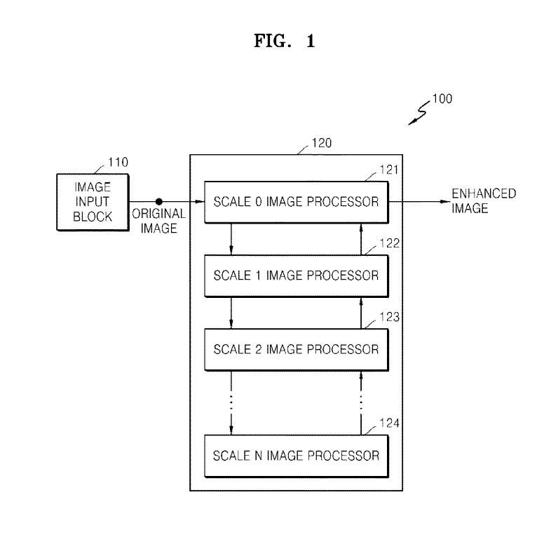

FIG. 1 is a diagram of an apparatus 100 for processing an image, according to an exemplary embodiment.

Referring to FIG. 1, the apparatus 100 includes an image input block 110 and a multi-resolution image processing block 120.

The image input block 110 outputs a predetermined image to the multi-resolution image processing block 120. The image input block 110 may transmit an image received from outside of the apparatus 100 to the multi-resolution image processing block 120.

Alternatively, the image input block 110 may directly generate the predetermined image by including a camera for capturing the image therein. For example, the image input block 110 may include a radiographic camera, and output an image captured by irradiating radioactive rays such as X-rays, magnetic rays or ultrasonic rays, etc, to the multi-resolution image processing block 120. An image transmitted from the image input block 110 to the multi-resolution image processing block 120 will hereinafter be referred to as an original image.

The multi-resolution image processing block 120 includes a plurality of scale 0 through scale N image processors 121 through 124, which output an enhanced image by analyzing and synthesizing the original image by using multi-resolution transformation.

In detail, the multi-resolution image processing block 120 analyzes, transforms, and synthesizes the original image by using the multi-resolution transformation. The scale 0 through scale N image processors 121 through 124 are connected in stages.

In detail, the scale 0 image processor 121 installed at a zeroth stage of the multi-resolution image processing block 120 scales the original image in a zeroth stage. In other words, the scale 0 image processor 121 does not change a size or resolution of the original image. An image output from the scale 0 image processor 121 is input to the scale 1 image processor 122 to be scaled in a first stage, and an image output from the scale 1 image processor 122 is input to the scale 2 image processor 123 to be scaled in a second stage. A size of an image is reduced by a predetermined ratio when scaled in the first stage. Also, a frequency band of an image may be reduced by half when scaled in the first stage.

Inversely, an image inverse-scaled in the scale 2 image processor 123 may be input to the scale 1 image processor 122, and an image inverse-scaled in the scale 1 image processor 122 may be input to the scale 0 image processor 121, and thus the scale 0 image processor 121 may output an enhanced image recovered in the size of the original image.

The zeroth through scale N image processors 121 through 124 are sequentially connected to each other, and each perform multi-resolution transformation. In other words, each of the zeroth through scale N image processors 121 through 124 decomposes an input image to have a predetermined resolution value, and transforms pixel values of the input image to a signal in a frequency domain. Here, an algorithm for transforming an input signal to a frequency domain or a spatial-frequency domain, such as a wavelet transform or a Laplace transform, may be used as a transform algorithm.

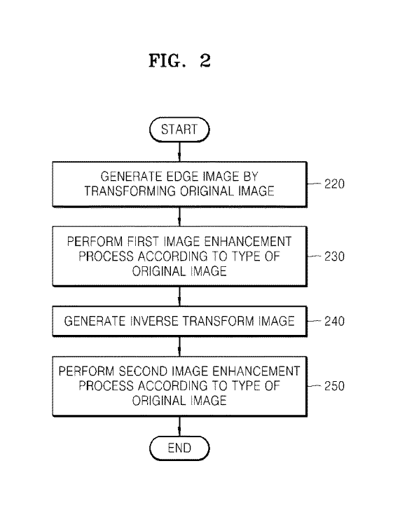

Each of the scale 0 through scale N image processors 121 through 124, for example, the scale 1 image processor 122, performs a method of processing an image, according to an exemplary embodiment as will be described with reference to FIG. 2.

FIG. 2 is a flowchart illustrating a method of processing an image, according to an exemplary embodiment.

Referring to FIG. 2, the method generates an edge image by transforming an original image in operation 220. In particular, the original image is transformed according to multi-resolution transformation, and the edge image corresponding to the transformed original image is generated.

According to the multi-resolution transformation, an input image is decomposed to components having predetermined frequency characteristics so as to scale a size of the input image. Accordingly, the scale 0 through scale N image processors 121 through 124 process frequency signals in different frequency bands, thereby scaling the original image in stages.

For example, in response to the original image being a signal having a frequency band of f1, the scale 0 image processor 121 may process the signal having the frequency band of f1, the scale 1 image processor 122 may process a signal having a frequency band of f½, the scale 2 image processor 123 may process a signal having a frequency band of f¼, and the scale N image processor 124 may process a signal having a frequency band of f½N.

Next, a first image enhancement process is performed on the edge image in operation 230, according to the type of original image. For example, at least one of a noise reduction process, an edge enhancement process, and a contrast enhancement process is performed on the edge image generated in operation 220. Also, other image processes applicable to a predetermined image may be performed in operation 230, in addition to or in place of the noise reduction process, the edge enhancement process, and the contrast enhancement process.

An inverse transform image is generated in operation 240 by performing inverse multi-resolution transformation on the edge image on which the first image enhancement process is performed in operation 230.

In operation 250, a second image enhancement process is performed on the inverse transform image according to the type of original image. For example, at least one of the noise reduction process, the edge enhancement process, and the contrast enhancement process is performed on the inverse transform image, except for the first image enhancement process performed in operation 230, according to a type of input image.

Operations 220 through 250 may be performed by the multi-resolution image processing block 120.

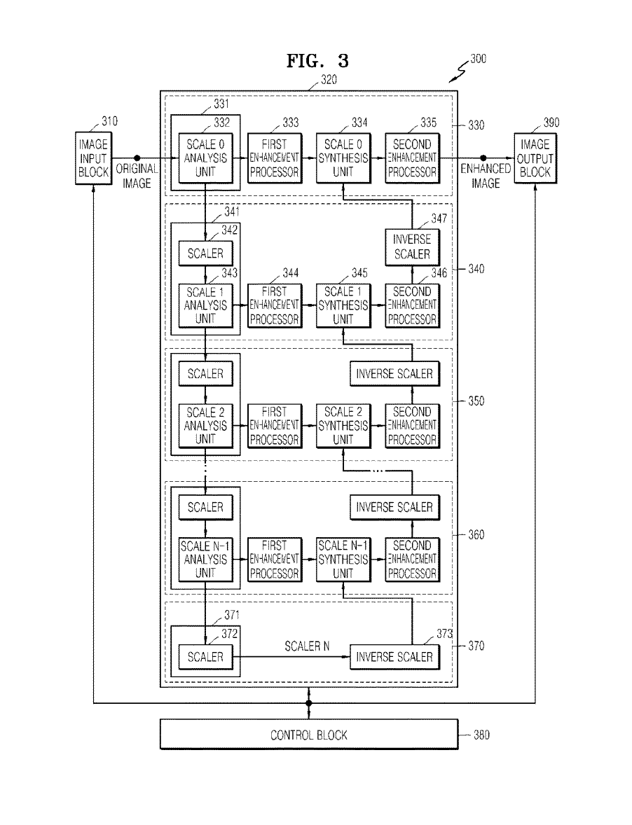

FIG. 3 is a diagram of an apparatus 300 for processing an image, according to another exemplary embodiment. In the apparatus 300, an image input block 310 and a multi-resolution image processing block 320 respectively correspond to the image input block 110 and the multi-resolution image processing block 120 of FIG. 1. Also, a scale 0 image processor 330, a scale 1 image processor 340, a scale 2 image processor 350, and an scale N image processor 370 of FIG. 3 respectively correspond to the scale 0 image processor 121, the scale 1 image processor 122, the scale 2 image processor 123, and the scale N image processor 124 of FIG. 1. Accordingly, overlapping descriptions in FIGS. 1 and 3 will not be repeated.

Referring to FIG. 3, each of the scale 0 through scale N image processors 330 through 370, for example, the scale 1 image processor 340, includes a scale unit 341, a first enhancement processor 344, a scale 1 synthesis unit 345, and a second enhancement processor 346. Also, the scale unit 341 may include a scaler 342 and a scale 1 analysis unit 343. Also, each of the scale zero through scale N image processors 330 through 370, for example, the scale 1 image processor 340, may further include an inverse scaler 347. Also, the apparatus 300 may further include a control block 380 and an image output block 390, compared to the apparatus 100 of FIG. 1.

In FIG. 3, the scale 0 image processor 330 includes a scale 0 analysis unit 332, a scale 0 synthesis unit 334, a first enhancement processor 333, and a second enhancement processor 335. As an alternative, a single processor within the multi-resolution processing block can carry out both the first and second enhancements.

As shown in FIG. 3, an image scaled in a scale zero stage by a scale unit 331 is input to the scale unit 341. In other words, the scale unit 341 performs first stage scaling by receiving a signal output from the scale unit 331 of the scale 0 image processor 330 that is in a previous stage. Also, the scale 0 synthesis unit 334 of the scale 0 image processor 330 receives an image signal output from the inverse scaler 347 of the scale 1 image processor 340 that is in a following stage.

Since the scale 0 through scale N image processors 330 through 370 perform the same operations, only the operations of the scale 1 image processor 340 will now be described, as an example.

The scale unit 341 transforms the original image by using multi-resolution transformation, generates the edge image corresponding to the transformed original image, and may include the scaler 342 and the scale 1 analysis unit 343. In other words, the scale unit 341 performs operation 220 of FIG. 2. Since the scale unit 331 in the stage 0 performs stage 0 as scale 0 scaling and thus does not substantially scale a size of an input image, the scale unit 331 does not include a scaler.

The edge image output from the scale unit 341 will be described later in detail with reference to FIG. 7.

The scaler 342 receives an image output from the scale unit 331 of the scale 0 image processor 330 in a previous stage, and performs the first stage scaling on the received image. A size and a frequency band of the image on which the first stage scaling is performed may be reduced by ¼ and by ½, respectively.

The scale 1 analysis unit 343 generates the edge image by transforming the original image by using the multi-resolution transformation. The generated edge image is input to the first enhancement processor 344. Also, the transformed image having the scaled size due to being passed through the scaler 342 and the scale analysis unit 343 is input to a scaler of the scale 2 image processor 350 in a following stage.

The first enhancement processor 344 performs operation 230 of FIG. 2. In particular, the first enhancement processor 344 performs the first image enhancement process, wherein at least one of the noise reduction process, the edge enhancement process, and the contrast enhancement process is performed on the edge image output from the scale 1 analysis unit 343, according to the type of original image. An image processing operation performed by the first enhancement processor 344 will now be referred to as a first image enhancement process operation, and corresponds to operation 230 of FIG. 2.

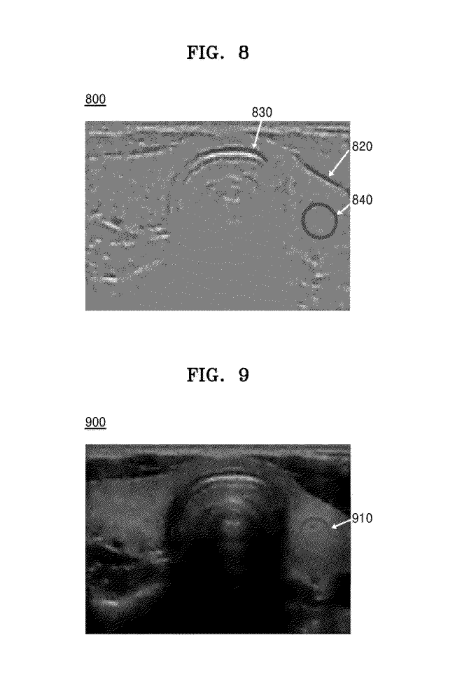

An image output from the first enhancement processor 344 will be described in detail later with reference to FIG. 8.

The scale 1 synthesis unit 345 performs operation 240 of FIG. 2. In other words, the scale 1 synthesis unit 345 generates an inverse transform image by performing inverse multi-resolution transformation on the edge image such that the image transformed by the scale unit 341 has at least one of the same size and frequency band as the image input to the scale 1 image processor 340.

The inverse transform image output from the scale 1 synthesis unit 345 will be described in detail later with reference to FIG. 9.

The second enhancement processor 346 performs operation 250 of FIG. 2. In particular, the second enhancement processor 346 performs at least one of the noise reduction process, the edge enhancement process, and the contrast enhancement process on the inverse transform image, except for a process performed by the first enhancement processor 344, according to the type of original image. An image processing operation performed by the second enhancement processor 346 will hereafter be referred to as a second image enhancement process operation, and corresponds to operation 250 of FIG. 2.

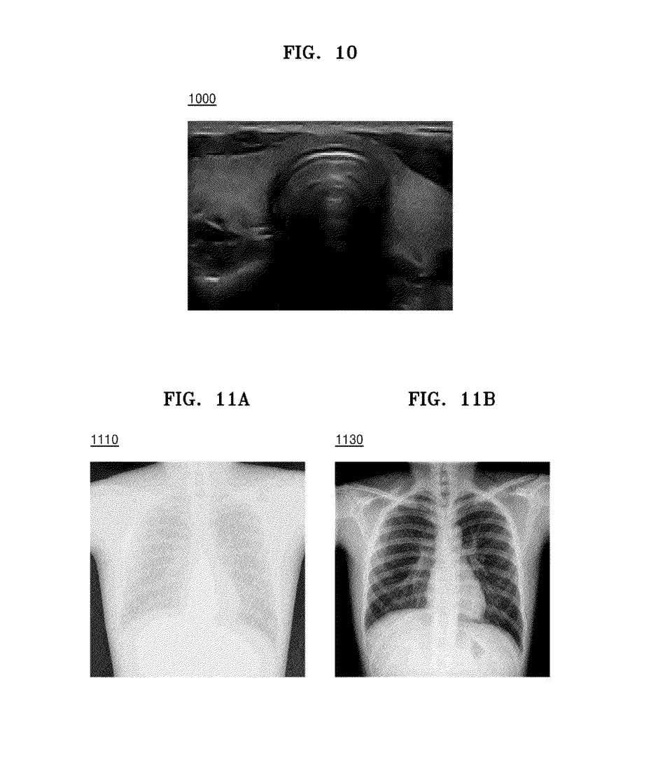

An image output from the second enhancement processor 346 will be described in detail later with reference to FIG. 10.

The inverse scaler 347 inverse-scales the image output from the second enhancement processor 346 to have the same size as the image input to the scale unit 341. In detail, if the size of the image input to the scale unit 341 is reduced by ½, the inverse scaler 347 doubles the size of the image.

In particular, the scale 1 synthesis unit 345 composes the image output from the first enhancement processor 344 and the image output from an inverse scaler included in the scale 2 image processor 350 in a following stage. Also, the inverse transform image is generated by performing the inverse multi-resolution transformation on the synthesized image such that the synthesized image is restored to the image input to the scale 1 image processor 340.

In the apparatus 300, the scale N image processor 370 in the last stage may not include a scale analysis unit, a first enhancement processor, a scale synthesis unit, and a second enhancement processor. In other words, the scale N image processor 370 may be a residual stage where transform and quality enhancing operations are not performed, and only a scaling operation is performed. In FIG. 3, the scale N image processor 370 is a residual stage.

The control block 380 may determine the type of the original image output from the image input block 310, and determine at least one of processes to be performed by, for example, the first enhancement processor 344 and the second enhancement processor 346, according to the determined type.

A valuable image quality element differs according to a type of an image. For example, in an x-ray image, a medical expert, such as a doctor, easily determines a disease when contrast is high. Meanwhile, in an ultrasonic image, the medical expert easily identifies a disease when noise is removed based on an edge of an object to be photographed so that images of internal organs are smoothed.

Thus, according to the current exemplary embodiment, the control block 380 determines the type of the image, and determines a type of image process to be performed by, for example, the first enhancement processor 344 and the second enhancement processor 346 according to the type of image. Accordingly, a most valuable image quality element may be first enhanced according to the type of image, thereby increasing the satisfaction of a user.

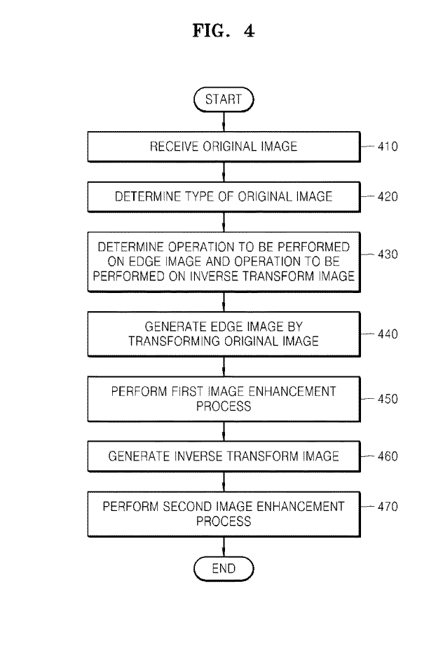

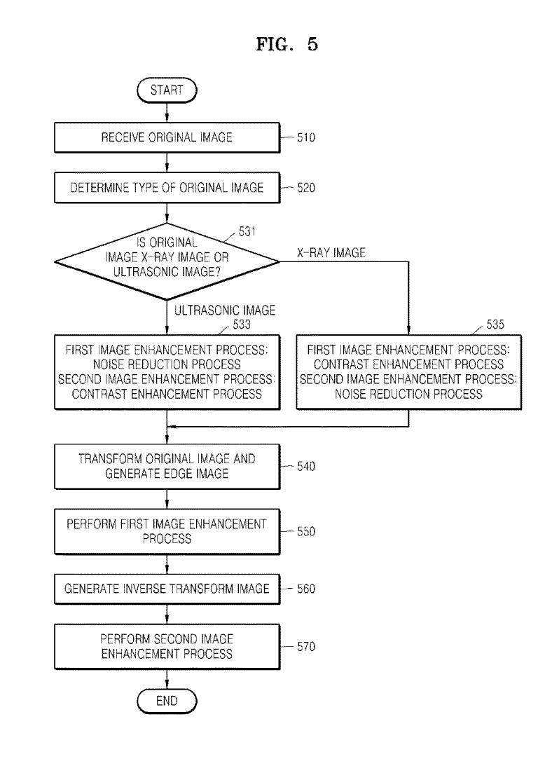

Detailed operations of the control block 380 will be described in detail later with reference to FIGS. 4 and 5.

The image output block 390 outputs an enhanced image output from the multi-resolution image processing block 320. In detail, the image output block 390 may include a display unit (not shown), and display an image visually recognizable to a user through the display unit.

FIG. 4 is a flowchart illustrating a method of processing an image, according to another exemplary embodiment. Since the method of FIG. 4 may be performed by the apparatus of FIG. 3, the method will now be described with reference to FIGS. 3 and 4.

Operations 440 through 470 of FIG. 4 respectively correspond to operations 220 through 250 of FIG. 2. Accordingly, overlapping descriptions thereof will not be repeated. The method of FIG. 4 may further include at least one of operations 410 through 430, unlike the method of FIG. 2.

Referring to FIG. 4, an original image is received in operation 410. Specifically, the image input block 310 transmits the original image to the multi-resolution image processing block 320. In particular, the scale 0 image processor 330 included in the multi-resolution image processing block 320 receives the original image.

A type of the original image is determined in operation 420. Operation 420 may be performed by the control block 380. In particular, the control block 380 receives the original image, and may directly analyze the original image to ascertain the type of original image. Alternatively, the control block 380 may receive information about the type of original image from a user or from an apparatus for capturing an image, such as a radiographic camera. Then, the control block 380 may determine the type of original image based upon the received information.

At least one of an operation to be performed in a first image enhancement process operation and an operation to be performed in a second image enhancement process operation is determined in operation 430, according to the type of image determined in operation 420. Operation 430 may be performed by the control block 380.

Here, operation 430 may be performed by the control block 380 or according to a user setting.

An edge image is generated by transforming the original image in operation 440. The edge image may be generated by repeating multi-resolution transformation on the original image a predetermined number of times or at predetermined stages according to resolution applied to the original image. For example, the original image may be output only after passing through the scale 1 image processor 340 or after passing through an N−1th stage image processor 360, according to a desired resolution. Whenever the original image passes through one image processor, multi-resolution transformation is performed one time or at one stage.

Also, operation 440 may further include generating an image characteristic map, such as an edge map or Eigen vector map. A scale unit, such as the scale unit 341 extracts edge information of an object included in an input image while generating the edge image. Accordingly, a scale analysis unit, such as a scale 1 analysis unit 343 may generate an edge map by using the extracted edge information.

A first image enhancement process is performed on the edge image in operation 450, according to the determination in operation 430. In operation 450, the first image enhancement process may be performed by using the image characteristic map, such as the edge map or Eigen vector map, generated in operation 440. For example, an internal region of an edge in which noise to be reduced may be determined by using an edge map. Alternatively, two different regions in which contrast is to be enhanced may be determined by using an edge map.

An inverse transform image is generated in operation 460 by performing inverse transformation on an image output in operation 450.

Then, a second image enhancement process is performed on the inverse transform image in operation 470, according to the determination of operation 430.

The image characteristic map, such as the edge map or Eigen vector map, generated in operation 440 may be used to perform the second image enhancement process in operation 470. A frequency band of an image may be reduced while passing through a scaler, for example, the scaler 342, and thus edge values may be lost. In operation 470, lost edge components may be emphasized by using the edge map generated in operation 440.

FIG. 5 is a flowchart illustrating a method of processing an image, according to another exemplary embodiment. Since the method of FIG. 5 may be performed by using the apparatus of FIG. 3, and somewhat overlaps with the method of FIG. 4, the method of FIG. 5 will now be described with reference to FIGS. 3, 4, and 5.

Since operations 510, 520, 540, 550, 560, and 570 of FIG. 5 respectively correspond to operations 410, 420, 440, 450, 460, and 470 of FIG. 4, overlapping descriptions will not be repeated. The method of FIG. 5 further includes operations 531, 533, and 535 corresponding to operation 430 of FIG. 4.

In operation 531, a determination is made as to whether the original image is an x-ray image or an ultrasonic image, based on the determination in operation 520. Operation 531 may be performed by the control block 380.

If the original image is the ultrasonic image, a noise reduction process is performed as the first image enhancement process and at least one of a contrast enhancement process and an edge enhancement process is performed as the second image enhancement process, in operation 533. In FIG. 5, the contrast enhancement process is performed as the second image enhancement process. Operation 533 may be performed by the control block 380.

If the original image is the ultrasonic image, it is most important to reduce noise included in the image, and thus a first enhancement processor, for example, the first enhancement processor 344, may perform the noise reduction process. Also, since the contrast enhancement process or the edge enhancement process is performed as the second enhancement image process, a second enhancement processor, for example, the second enhancement processor 346 may perform at least one of the contrast enhancement process and the edge enhancement process.

If the original image is the x-ray image, at least one of the contrast enhancement process and the edge enhancement process is performed as the first image enhancement process, and the noise reduction process is performed as the second image enhancement process, in operation 535. In FIG. 5, the contrast enhancement process is performed as the first image enhancement process. Operation 535 may be performed by the control block 380.

For example, if the original image is the x-ray image, it is most important to clearly classify bones, muscle tissues, or internal organs from each other by improving contrast of the original image. Accordingly, a first enhancement processor, for example the first enhancement processor 344, may perform the contrast enhancement process. Also, since the noise reduction process may be performed as the second image enhancement process, a second enhancement processor, such as the second enhancement processor 346, may perform the noise reduction process.

In operation 550, the first enhancement processor 344 performs the first image enhancement process according to the determination of the control block 380.

Also, in operation 570, the second enhancement processor 346 performs the second image enhancement process according to the determination of the control block 380.

As described above, since methods and apparatuses for processing an image according to the embodiments of the present invention perform an optimized image process operation according to a type of an image, an image quality element of an image desired by a user may be first enhanced. Also, since an image process is performed before and after scaling and composing, two different image processes may be performed by an image processor that performs multi-resolution transformation.

In addition, by using an edge map which was used during a first image enhancement process, in a second image enhancement process data is shared between first and second enhancement processors, and thus the amount of data used may be reduced.

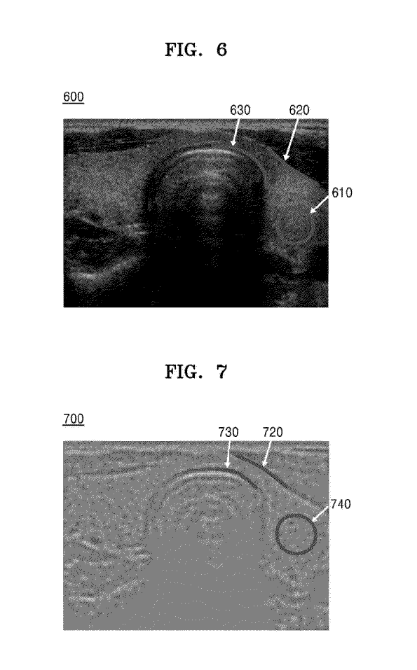

FIG. 6 is a view of an original image 600 transmitted from the image input block 310 of FIG. 3. In FIGS. 6 through 10, an ultrasonic image is input to the apparatus 300 as an original image.

Referring to FIG. 6, the multi-resolution transformation and image process are not performed on the original image 600 output from the image input block 310. The original image 600 includes edges 620 and 630 of photographed objects. Also, the original image 600 includes a noise component 610. The original image 600 may be an image input in operation 510 of FIG. 5.

FIG. 7 is a view of an edge image 700 output from a scale unit, for example the scale unit 341 of FIG. 3. As described above, the scale unit 341 generates and outputs the edge image 700. The scale unit 341 extracts edge information from the original image 600 of FIG. 6, and generates the edge image 700 in which edges 720 and 730 are emphasized. The edge image 700 still includes a noise component 740 corresponding to the noise component 610 in the original image 600 of FIG. 6.

The edge image 700 may be an image generated in operation 540 of FIG. 5.

FIG. 8 is a view of an image 800 output from a first enhancement processor, for example, the first enhancement processor 344 of FIG. 3.

Referring to FIG. 8, the first enhancement processor 344 outputs the image 800 by performing a noise reduction process on the edge image 700. In the image 800, the noise component 740 included in the edge image 700 is removed. Since the image 800 is an ultrasonic image, the first enhancement processor 344 first performs a noise reduction process. Accordingly, the noise component 610 included in the original image 600 is reduced overall in the image 800.

The image 800 may be an image output in operation 550 of FIG. 5.

FIG. 9 is a view of an inverse transform image 900 output from a scale synthesis unit, for example, the scale synthesis unit 345 of FIG. 3.

Referring to FIG. 9, the scale synthesis unit 345 restores the image output from the first enhancement processor 344 to the image input to the scale 1 image processor 340. A noise component 910 in the inverse transform image 900 constituting the restored image is almost completely removed compared to the original image 600.

The inverse transform image 900 may be an image output in operation 560 of FIG. 5.

FIG. 10 is a view of an image 1000 output from a second enhancement processor, for example, the second enhancement processor 346 of FIG. 3.

Referring to FIG. 10, the second enhancement processor 346 performs a contrast enhancement process on the inverse transform image 900 and outputs the image 1000. The image 1000 output by the second enhancement processor 346 has reduced noise and enhanced contrast compared to the original image 600. Accordingly, a medical expert may easily read an ultrasonic image by using the image 1000.

Enhanced images generated according to the methods and apparatuses for processing an image according to exemplary embodiments, and original images, are compared in FIGS. 11A and 11B.

FIGS. 11A and 11B are views of an input image and an output image according to an exemplary embodiment. In FIGS. 11A and 11B, an original image is an x-ray image.

FIG. 11A illustrates an original image 1110 output from the image input block 310. Also, FIG. 11B illustrates an enhanced image 1130 output from the multi-resolution image processing block 320.

Comparing the original image 1110 and the enhanced image 1130, the enhanced image 1130 has higher contrast, clearer edges, and low noise components. Accordingly, a medical expert may easily determine existence of disease from reading enhanced image 1130.

The invention can also be embodied as computer readable codes on a computer readable recording medium. The computer readable recording medium is any data storage device that can store data structures which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of processing an image, the method comprising:
transforming an original image by generating an edge image using multi-resolution transformation;
performing a first image enhancement process on the edge image according to a type of original image;
generating an inverse transform image by performing inverse multi-resolution transformation on the edge image; and
performing a second image enhancement process on the inverse transform image according to a type of an original image.

2. The method of claim 1, further comprising:
determining the type of original image; and
determining at least one of the first image enhancement process and the second image enhancement process according to the determined type.

3. The method of claim 1, wherein the performing of the first image enhancement process comprises performing at least one of a noise reduction process, an edge enhancement process, and a contrast enhancement process on the edge image, according to the type of the original image, and
the performing of the second image enhancement process comprises performing at least one of the noise reduction process, the edge enhancement process, and the contrast enhancement process, except for a process that is performed on the edge image, on the inverse transform image, according to the type of original image.

4. The method of claim 2, wherein determining the type of original image comprises determining whether the original image is an x-ray image or an ultrasonic image.

5. The method of claim 4, wherein the performing of the first image enhancement process comprises performing the noise reduction process on the edge image in response to the original image being determined to be the ultrasonic image.

6. The method of claim 5, wherein the performing of the second image enhancement process comprises performing at least one of the edge enhancement process and the contrast enhancement process on the inverse transform image in response to the original image being determined to be the ultrasonic image.

7. The method of claim 4, wherein the performing of the first image enhancement process comprises performing at least one of the edge enhancement process and the contrast enhancement process on the edge image in response to the original image being determined to be the x-ray image.

8. The method of claim 7, wherein the performing of the second image enhancement process comprises performing the noise reduction process on the inverse transform image in response to the original image being determined to be the x-ray image.

9. The method of claim 1, wherein the generating of the edge image further comprises repeatedly performing the multi-resolution transformation on the original image a predetermined number of times according to a resolution applied to the original image.

10. The method of claim 9, wherein the generating of the inverse transform image further comprises repeatedly performing the inverse multi-resolution transformation the predetermined number of times.

11. The method of claim 1, wherein the generating of the edge image further comprises generating an edge map comprising edge information of at least one object included in the transformed original image.

12. The method of claim 11, wherein the performing of the second image enhancement process comprises performing the second image enhancement process on the inverse transform image by using the edge map.

13. An apparatus for processing an image, the apparatus comprising:
an image input block which receives an original image; and
a multi-resolution image processing block comprising a plurality of image processors for analyzing and synthesizing the original image transmitted from the image input block by using multi-resolution transformation,
wherein each of the plurality of image processors transforms the original image by using the multi-resolution transformation, generates an edge image corresponding to the transformed original image, performs a first image enhancement process on the edge image according to a type of the original image, generates an inverse transform image by performing inverse multi-resolution transformation on the edge image, and performs a second image enhancement process on the inverse transform image according to the type of original image.

14. The apparatus of claim 13, further comprising a control block for determining the type of original image and determining at least one of the first image enhancement process and the second image enhancement process according to the determined type of the original image.

15. The apparatus of claim 13, wherein each of the plurality of image processors performs at least one of a noise reduction process, an edge enhancement process, and a contrast enhancement process on the edge image according to the type of the original image, and performs at least one of the noise reduction process, the edge enhancement process, and the contrast enhancement process, except for a process that is performed on the edge image, on the inverse transform image, according to the type of original image.

16. The apparatus of claim 14, wherein the control block determines whether the original image is an x-ray image or an ultrasonic image.

17. The apparatus of claim 16, wherein the control block sets the first image enhancement process to be the noise reduction process and sets the second image enhancement process to be at least one of the edge enhancement process and the contrast enhancement process, in response to the original image being the ultrasonic image.

18. The apparatus of claim 16, wherein the control block sets the first image enhancement process to be at least one of the edge enhancement process and the contrast enhancement process and sets the second image improvement process as the noise reduction process, in response to the original image being the x-ray image.

19. The apparatus of claim 13, wherein each of the plurality of image processors comprises:
a scale unit which transfers the original image by using the multi-resolution transformation and generating the edge image corresponding to the transformed original image;
a first enhancement processor which performs at least one of a noise reduction process, an edge enhancement process, and a contrast enhancement process on the edge image, according to the type of the original image;
a scale synthesis unit which generates the inverse transform image by performing the inverse multi-resolution transformation on the edge image such that the transformed original image is a same size as the original image; and
a second enhancement processor which performs at least one of the noise reduction process, the edge enhancement process, and the contrast enhancement process, except for a process that is performed on the edge image, on the inverse transform image, according to the type of original image.

20. The apparatus of claim 19, wherein the multi-resolution image processing block comprises the plurality of image processors that are connected in stages, and at least one of image processors among the plurality of image processors further comprises:
a scaler which scales an image output from a scale analysis unit included in an image processor of a previous stage; and
an inverse scaler which inverse-scales an image output from the second enhancement processor.

21. The apparatus of claim 20, wherein the scale synthesis unit synthesizes an image output from the inverse scaler included in an image processor of a following stage, and an image output from the scale analysis unit from a previous stage, and performs the inverse multi-resolution transformation on the synthesized image.

22. The apparatus of claim 19, wherein the scale unit generates an edge map comprising edge information of at least one object included in the original image.

23. The apparatus of claim 20, wherein the second enhancement processor performs at least one of the noise reduction process, the edge enhancement process, and the contrast enhancement process, except for a process performed on the edge image, on the inverse transform image by using the edge map.

24. An apparatus for processing an image, the apparatus comprising:
a multi-resolution image processing block which comprises:
an analysis unit which transforms an input original image by generating an edge image using multi-resolution image transformation;
a processor which performs a first image enhancement process on the edge image;
a synthesis unit which generates an inverse transform image by performing inverse multi-resolution transformation on the edge image, and
the processor performing a second image enhancement process on the inverse transform image.

25. (canceled)

26. The apparatus of claim 24, wherein the analysis unit is a scale unit and the synthesis unit is a scale synthesis unit which inverse scales the edge image such that the inverse scaled image is the same size as the original image.

27. The apparatus of claim 26, wherein the multi-resolution image processing block further comprises a plurality of image processors which are connected in stages.
